(19) United States
(12) Patent Application Publication
(10) Pub. No.: US 2023/0178834 A1
(43) Pub. Date: Jun. 8, 2023

(54) Energy Cell Holding Device, Rechargeable Battery Pack with Energy Cell Holding Device, and System with Rechargeable Battery Pack

(71) Applicant: Robert Bosch GmbH, Stuttgart (DE)

(72) Inventors: Marcin Rejman, Waiblingen (DE); Jin Kee Sim, Penang (MY); Kumaraguru Krishnan, Penang (MY)

(21) Appl. No.: 18/060,926

(22) Filed: Dec. 1, 2022

(30) Foreign Application Priority Data
Dec. 2, 2021 (DE) 102021213654.0

(51) Int. Cl. H01M 50/244; H01M 50/213; H01M 50/264

(52) U.S. Cl. CPC H01M 50/244; H01M 50/213; H01M 50/264

(57) ABSTRACT

An energy cell holding device for an energy storage device, in particular a rechargeable battery pack, is disclosed. The energy cell holding device includes at least one cell holder unit for receiving at least one energy cell, the cell holder unit having at least one cell holder element which at least partially delimits at least one energy cell receiving region, in particular a single energy cell receptacle, for the energy cell. The energy cell holding device further includes at least one clamping unit which has at least one clamping element provided for clamping the energy cell which can be arranged in the energy cell receiving region in the cell holder element when the energy cell is arranged in the energy cell receiving region. The clamping unit has at least one further clamping element which is designed to additionally clamp the energy cell which can be arranged in the energy cell receiving region.

This application claims priority under 35 U.S.C. § 119 to patent application no. DE 10 2021 213 654.0, filed on Dec. 2, 2021 in Germany, the disclosure of which is incorporated herein by reference in its entirety.

### BACKGROUND

An energy cell holding device for an energy storage device comprising at least one cell holder unit for receiving at least one energy cell, the cell holder unit having at least one cell holder element which at least partially delimits at least one energy cell receiving region for the energy cell, and comprising at least one clamping unit which comprises at least one clamping element provided for clamping the energy cell which can be arranged in the energy cell receiving region in the cell holder element when the energy cell is arranged in the energy cell receiving region has already been proposed.

### SUMMARY

The disclosure relates to an energy cell holding device for an energy storage device, in particular a rechargeable battery pack, comprising at least one cell holder unit for receiving at least one energy cell, the cell holder unit having at least one cell holder element which at least partially delimits at least one energy cell receiving region, in particular a single energy cell receptacle, for the energy cell, and comprising at least one clamping unit which comprises at least one clamping element provided for clamping the energy cell which can be arranged in the energy cell receiving region in the cell holder element when the energy cell is arranged in the energy cell receiving region.

The disclosure proposes that the clamping unit has at least one further clamping element which is designed to additionally clamp the energy cell which can be arranged in the energy cell receiving region. The clamping unit is in particular different from electrical contact elements of the rechargeable battery pack that are provided for electrically contacting the energy cell. In particular, the clamping unit is provided for clamping the energy cell to the cell holder element in at least two different ways, preferably in at least two successive steps. Preferably, the at least one clamping element is provided to at least partially clamp, in particular pre-fix, the energy cell on, preferably in, the cell holder element with a clamping force. Preferably, the further clamping element is provided to exert an additional clamping force on the energy cell, which is in particular already at least partially clamped, in particular pre-fixed, to the cell holder element by means of the clamping element in order to additionally clamp the energy cell to the cell holder element. Preferably, a clamping force that can be generated by means of the clamping element is smaller than a clamping force that can be generated by means of the further clamping element. Alternatively, it is, however, also conceivable that a clamping force that can be generated by means of the clamping element is greater than a clamping force that can be generated by means of the further clamping element or that a clamping force that can be generated by means of the clamping element is equal to a clamping force that can be generated by means of the further clamping element. Alternatively it is, however, also conceivable that the clamping unit is provided to clamp the energy cell to the cell holder element only in one way, in particular to completely clamp it by means of the clamping element or the further clamping element. The at least one clamping element is preferably arranged on the cell holder element and is in particular formed in one piece with the cell holder element. The term “in one piece” can be understood to mean at least integrally bonded, for example by means of a welding process, an adhesion process, an injection process and/or another process that appears expedient to a person skilled in the art, and/or advantageously molded in one piece, for example by production from a casting and/or by production in a single-component or multi-component injection molding process, and advantageously from a single blank. Furthermore, it is also conceivable that at least two clamping elements are arranged on the cell holder element, in particular are formed in one piece therewith. Particularly preferably, the clamping element is formed by the cell holder element. Alternatively it is, however, also conceivable for the clamping element to be formed separately from the cell holder element. In particular, it is alternatively conceivable that the at least one clamping element is arranged on a side face of the cell holder unit, in particular on a side face of a cell holder base body of the cell holder unit. The clamping element is preferably designed as an elastic, in particular rubber-elastic, element. The clamping element is in particular arranged on, preferably in, the energy cell receiving region such that the clamping element is arranged at least partially, preferably at least substantially completely, within the energy cell receiving region. Preferably, the at least one clamping element is arranged on, in particular in, the energy cell receiving region such that the energy cell can be arranged in the energy cell receiving region by deformation of the clamping element and/or by a displacement, in particular a purely linear displacement, of the clamping element. Alternatively or additionally, in particular in the case of a one-piece design of the clamping element with the cell holder element, it is conceivable that the at least one clamping element is arranged on, in particular in, the energy cell receiving region such that the energy cell can be arranged in the energy cell receiving region by deformation of the cell holder unit, in particular of the cell holder base body, preferably of the cell holder element. The clamping element may, for example, be web-like, knob-like, polygonal, or have another shape that appears expedient to a person skilled in the art. A restoring force, which acts as a clamping force on the energy cell, can preferably be generated by deformation of the elastic, in particular rubber-elastic, clamping element, which deformation can be generated as a result of the energy cell being inserted into the energy cell receiving region. In particular, the clamping element is arranged on an inner wall of the energy cell receiving region. The clamping element preferably forms an extension of the inner wall of the energy cell receiving region. Alternatively, it is also conceivable, for example, for the clamping unit to comprise at least one spring element, which is provided to preload the at least one clamping element. Preferably, the clamping element projects, in particular laterally, into the energy cell receiving region. In particular, the at least one clamping element is preloaded and/or arranged by means of the at least one spring element such that by inserting the energy cell into the energy cell receiving region, the clamping element can be displaced against a restoring force that can be generated by the spring element, preferably in order to exert a clamping force on the energy cell. The spring element can be designed, for example, as a spiral spring, a leaf spring, a wave spring, a torsion spring, a compression spring, a conical spring, a barrel spring or another spring element that appears expedient to a person skilled in the art. The energy cell with the cell holder element can preferably be clamped to the cell holder element by a restoring force that can be generated by deformation of the clamping element when the energy cell is being arranged in the energy cell receiving region.

The further clamping element is preferably designed to be different from the clamping element. It is conceivable that the clamping unit comprises only the at least one further clamping element or a plurality of further clamping elements. The plurality of further clamping elements may, for example, be designed to be at least partially identical to one another or at least partially different from one another. The at least one further clamping element is preferably bolt-shaped, in particular in at least one exemplary embodiment. Alternatively, it is also conceivable for the at least one further clamping element to have a pin-shaped, plate-shaped, cubic, spherical, wedge-shaped or ramp-shaped design or to have another design that appears expedient to a person skilled in the art. The at least one further clamping element has, for example, a circular cylindrical, a conical or another shape that appears expedient to a person skilled in the art. It is conceivable that the further clamping element has a polygonal cross section, a circular cross section or another cross section that appears expedient to a person skilled in the art. The cross section of the further clamping element preferably extends in a plane perpendicular to a main extension axis of the further clamping element. In this case, the term “main extension axis” of an object can in particular be understood to mean an axis which extends in parallel with a longest edge of a smallest geometric cuboid which only just completely encloses the object. It is also conceivable for the at least one further clamping element to be designed as an elastic, in particular rubber-elastic, element. In particular, it is conceivable that the at least one further clamping element, preferably designed as an elastic element, particularly preferably as a rubber-elastic element, is arranged on a side face of the cell holder unit, in particular on a side face of the cell holder base body of the cell holder unit. Preferably, the further clamping element, which can be arranged on the side face of the cell holder unit, in particular on the side face of the cell holder base body, and is preferably formed from an elastic, in particular rubber-elastic, material is plate-shaped. Alternatively, it is also conceivable that the further clamping element, which can be arranged on the side face of the cell holder unit, in particular on the side face of the cell holder base body, and is preferably formed from an elastic, in particular rubber-elastic, material is cubic, spherical or the like.

It is conceivable that the cell holder unit only comprises one or more cell holder elements. For example, the plurality of cell holder elements form a honeycomb-like structure. Preferably, the at least one cell holder element is arranged on the cell holder base body and is in particular formed in one piece with the cell holder base body. Particularly preferably, the at least one cell holder element is formed by the cell holder base body. Alternatively, it is, however, also conceivable that the at least one cell holder element can be arranged detachably, in particular detachably in a non-destructive manner, on the cell holder base body. The cell holder base body is preferably formed in one piece. However, it is alternatively also conceivable for the cell holder base body to be formed in multiple parts, for example in two parts. In the cell holder unit comprising a plurality of cell holder elements, the plurality of cell holder elements are preferably formed in one piece with one another. Alternatively, it is, however, also conceivable that in the cell holder unit comprising a plurality of cell holder elements, the plurality of cell holder elements are formed separately from one another and can preferably be arranged detachably, in particular detachably in a non-destructive manner, on the cell holder base body. The energy cell receiving region at least partially delimited by the at least one cell holder element is preferably designed as a single energy cell receptacle. The at least one cell holder element, in particular the energy cell receiving region, is preferably formed by a recess in the cell holder unit, in particular in the cell holder base body. The energy cell receiving region is preferably designed as a receiving shaft for the at least one energy cell, into which the energy cell can be introduced, in particular inserted. The energy cell receiving region designed as a single energy cell receiving region is preferably provided for receiving a single energy cell. Alternatively, it is, however, also conceivable for the energy cell receiving region to be provided for receiving at least two energy cells.

The at least one cell holder element, preferably the cell holder base body, is preferably formed at least substantially completely from an elastic, in particular rubber-elastic, material. The term “at least substantially completely” can be understood to mean at least 50%, preferably at least 75%, and particularly preferably at least 90%, of a total volume and/or a total mass of an object, in particular of the cell holder element. Alternatively, it is, however, also conceivable for the cell holder element, in particular the cell holder base body, to be formed at least substantially completely free of an elastic, preferably rubber-elastic, material. In particular, in order to generate a clamping force on the energy cell, the at least one further clamping element is provided to deform the at least one cell holder element, preferably the cell holder base body, in order to clamp the energy cell in the cell holder element. Alternatively or additionally, it is also conceivable for the at least one further clamping element to be provided to generate a clamping force directly on the energy cell in order to clamp the energy cell in the cell holder element. The energy cell is preferably designed as a rechargeable battery cell. Alternatively, it is, however, also conceivable that the energy cell is designed as a primary cell or another energy cell that appears expedient to a person skilled in the art. Preferably, the energy cell has a main extension axis. Preferably, the energy cell is rotationally symmetrical, in particular with regard to rotations about the main extension axis of the energy cell. In particular, the energy cell is circular cylindrical. Alternatively, it is, however, also conceivable for the energy cell to be flat or spherical or to have another shape that appears expedient to a person skilled in the art. Preferably, the clamping element is provided to exert a clamping force on the energy cell that is directed onto the energy cell transversely, in particular perpendicularly, particularly preferably radially, relative to the main extension axis of the energy cell. Preferably, the further clamping element, which is preferably bolt-shaped in at least one exemplary embodiment, is provided to exert a clamping force on the energy cell that is directed onto the energy cell transversely, in particular perpendicularly, particularly preferably radially, relative to the main extension axis of the energy cell. Alternatively, it is, however, also conceivable that the further clamping element, which can preferably be arranged on the side face of the cell holder unit, in particular on the side face of the cell holder base body, is in particular formed from an elastic, in particular rubber-elastic, material and is preferably plate-shaped, is provided to exert a clamping force on the energy cell that is directed onto the energy cell at least substantially in parallel with the main extension axis of the energy cell. The term “substantially in parallel” can be understood here to mean an orientation of a direction relative to a reference direction, in particular in a plane, the direction having a deviation in particular of less than 8°, advantageously less than 5°, and particularly advantageously less than 2°, with respect to the reference direction.

As a result of the design according to the disclosure of the energy cell holding device, a particularly reliable and flexible clamping of energy cells in a cell holder element can advantageously be realized. Advantageously, an energy cell holding device can be provided which has a particularly high tolerance to, for example, manufacturing-related energy-cell dimensional variations. Advantageously, a clamping force can be adjusted flexibly by the use of at least two different clamping elements, in particular the clamping element and the further clamping element. Advantageously, component tolerances, preferably with respect to energy cells to be clamped, can be compensated particularly easily and reliably by using at least two different clamping elements, in particular the clamping element and the further clamping element. Advantageously, a particularly accurately fitting and reliable fixing of energy cells, the dimensions of which are subject to variations, can be made possible. Advantageously, damage to energy cells, which in particular are subject to dimensional variations, can be counteracted. A particularly high degree of mounting convenience in the case of energy cells with dimensional variations can advantageously be realized.

It is furthermore proposed that, in order to additionally clamp the energy cell which can be arranged in the energy cell receiving region, the further clamping element can be arranged, in particular variably, on the cell holder unit when the energy cell is arranged in the energy cell receiving region. The at least one further clamping element is in particular formed separately from the cell holder unit, preferably at least separately from the at least one cell holder element and/or the cell holder base body. In order to additionally clamp the energy cell which can be arranged in the energy cell receiving region, the at least one further clamping element is preferably provided to be attached to the cell holder unit, preferably to the cell holder base body, when the energy cell is arranged in the energy cell receiving region. Preferably, the clamping unit has at least one clamping element receptacle, to which, preferably in which, the at least one further clamping element can be attached when the energy cell is arranged in the energy cell receiving region in order to additionally clamp the energy cell which can be arranged in the energy cell receiving region. The at least one clamping element receptacle is preferably formed as a recess, in particular as a receiving shaft for the at least one further clamping element, in the cell holder base body. Alternatively, it is also conceivable for the clamping element receptacle to be formed by a side face of the cell holder unit, in particular by a side face of the cell holder base body. Preferably, the cell holder unit, in particular the cell holder base body, has a plurality of clamping element receptacles, preferably arranged at a distance from one another, in particular in order to arrange the at least one further clamping element variably on the cell holder unit, in particular on the cell holder base body, when the energy cell is arranged in the energy cell receiving region in order to additionally clamp the energy cell which can be arranged in the energy cell receiving region. Particularly preferably, the plurality of clamping element receptacles are each provided for receiving at least one of the plurality of further clamping elements. It is conceivable that the plurality of clamping element receptacles are designed to be at least partially identical to one another and/or are designed to be at least partially different from one another. Alternatively, it is, however, also conceivable for the cell holder unit, preferably the cell holder base body, to have only one clamping element receptacle on which the at least one further clamping element can be arranged, preferably variably, when the energy cell is arranged in the energy cell receiving region in order to additionally clamp the energy cell which can be arranged in the energy cell receiving region. Advantageously, a clamping force for clamping energy cells can be adapted particularly easily and conveniently. Advantageously, a clamping force can be increased flexibly as required by means of the at least one further clamping element. Advantageously, the at least one further clamping element can be conveniently and easily dispensed with if a clamping force by means of the at least one clamping element is already sufficient. Particularly convenient clamping of energy cells of different dimensions can advantageously take place.

It is moreover proposed that the clamping unit is designed such that a clamping force on an energy cell which can be arranged in the energy cell receiving region can be adjusted when the energy cell is arranged in the energy cell receiving region by arranging the further clamping element relative to the energy cell receiving region. Preferably, a clamping force on the energy cell which can be arranged in the energy cell receiving region can be adjusted when the energy cell is arranged in the energy cell receiving region by variably arranging the further clamping element on, preferably in, the clamping element receptacle. In particular, a clamping force on the energy cell which can be arranged in the energy cell receiving region is dependent, when the energy cell is arranged in the energy cell receiving region, on which of the plurality of clamping element receptacles the further clamping element is arranged on, preferably in. Preferably, a clamping force on the energy cell which can be arranged in the energy cell receiving region is dependent, when the energy cell is arranged in the energy cell receiving region, on which number of further clamping elements the plurality of clamping element receptacles are arranged on, preferably in. Advantageously, a clamping force for clamping an energy cell when the energy cell is arranged in the energy cell receiving region can be adapted particularly precisely and flexibly. Particularly reliable clamping of energy cells, in particular also of energy cells that have, for example, manufacturing-related dimensional variations, can advantageously be achieved. Advantageously, a clamping force can be adapted particularly easily and conveniently to different requirements, for example use-related requirements.

It is furthermore proposed that in order to additionally clamp the energy cell which can be arranged in the energy cell receiving region, the further clamping element can be inserted into the cell holder unit when the energy cell is arranged in the energy cell receiving region. Preferably, in order to additionally clamp the energy cell which can be arranged in the energy cell receiving region, the at least one further clamping element can be inserted into the clamping element receptacle formed as a recess in the cell holder base body when the energy cell is arranged in the energy cell receiving region. Preferably, the further clamping element is provided to deform the cell holder unit, in particular the cell holder base body, and preferably the cell holder element, as a result of inserting the further clamping element into the cell holder unit, in particular into the clamping element receptacle. In particular, the further clamping element can be inserted into the cell holder unit, preferably into the cell holder base body, preferably into the clamping element receptacle, such that, as a result of the deformation generated thereby of the cell holder unit, in particular of the cell holder base body, and particularly preferably of the at least one cell holder element, when the energy cell is arranged in the energy cell receiving region, a clamping force can be generated on the energy cell which can be arranged in the energy cell receiving region. Alternatively, it is also conceivable that the clamping element receptacle is arranged relative to the energy cell receiving region such that the at least one further clamping element can be inserted into the cell holder unit, preferably into the cell holder base body, preferably into the clamping element receptacle, such that, when the energy cell is arranged in the energy cell receiving region, the at least one further clamping element directly abuts the energy cell which can be arranged in the energy cell receiving region, and a clamping force can preferably be generated directly on the energy cell by the at least one further clamping element. Advantageously, the at least one energy cell can be clamped particularly reliably and easily even when dimensional variations exist. Advantageously, the at least one further clamping element can be arranged in a space-saving manner.

Furthermore, it is proposed that, when the energy cell is arranged in the energy cell receiving region, the further clamping element can be inserted into the cell holder unit in order to additionally clamp the energy cell which can be arranged in the energy cell receiving region, it being possible for a clamping force acting on the energy cell to be adjusted via an insertion depth of the further clamping element relative to the cell holder unit, in particular relative to the cell holder base body, preferably relative to the clamping element receptacle. Preferably, a deformation of the cell holder base body, in particular of the cell holder element, and thus preferably also a clamping force on the energy cell which can be arranged in the energy cell receiving region is dependent, when the energy cell is arranged in the energy cell receiving region, on an insertion depth of the at least one further clamping element relative to the cell holder unit, in particular relative to the cell holder base body, preferably relative to the clamping element receptacle. In particular, a deformation of the cell holder base body, preferably of the cell holder element, and thus preferably also a clamping force on the energy cell which can be arranged in the energy cell receiving region, can be increased when the energy cell is arranged in the energy cell receiving region by a deeper insertion of the further clamping element relative to the cell holder unit, in particular the clamping element receptacle. Advantageously, a clamping force for additionally clamping an energy cell when the energy cell is arranged in the energy cell receiving region can be achieved particularly easily and conveniently. Advantageously, energy cells with, for example, manufacturing-related dimensional variations can be clamped particularly reliably in the cell holder element. Advantageously, a clamping force on the at least one energy cell can be adapted particularly easily and conveniently to, for example, use-related requirements.

It is furthermore proposed that, in order to additionally clamp the energy cell which can be arranged in the energy cell receiving region, the further clamping element can be inserted into the cell holder unit when the energy cell is arranged in the energy cell receiving region, the further clamping element being rotationally symmetrical. The cross section of the further clamping element is preferably rotationally symmetrical, in particular with respect to the main extension axis of the further clamping element. Particularly preferably, the further clamping element is rotationally symmetrical in the narrower sense, in particular with respect to rotations about the main extension axis of the further clamping element. The further clamping element, which is rotationally symmetrical in the narrower sense, is in particular designed such that the further clamping element maps onto itself as it rotates by any angle about the main extension axis, for example when the cross section of the further clamping element forms a circle. Alternatively, it is also conceivable that the further clamping element, in particular the cross section of the further clamping element, has an n-fold rotational symmetry. n may in particular be a natural number greater than 1. The n-fold rotationally symmetrical further clamping element maps onto itself in particular as it rotates by an angle α=360°/n about the main extension axis of the further clamping element. For example, the cross section of the n-fold rotationally symmetrical further clamping element forms a triangle, a square, a pentagon, a hexagon, or another n-fold rotationally symmetrical geometric figure that appears expedient to a person skilled in the art. Advantageously, when the energy cell is arranged in the energy cell receiving region, a particularly easy and convenient assembly, in particular a particularly easy insertion of the further clamping element into the clamping element receptacle, can take place in order to additionally clamp the energy cell which can be arranged in the energy cell receiving region.

It is moreover proposed that, in order to additionally clamp the energy cell which can be arranged in the energy cell receiving region, the further clamping element can be inserted into the cell holder unit when the energy cell is arranged in the energy cell receiving region, the further clamping element being wedge-like. In particular, the at least one further clamping element is wedge-like when viewed in parallel with the main extension axis of the further clamping element. The further clamping element is preferably designed to taper off. Preferably, the at least one further clamping element is conical. Particularly preferably, the at least one further clamping element has the shape of a truncated cone. Alternatively, it is also conceivable for the further clamping element to be pyramidal or to have another wedge-like design that appears expedient to a person skilled in the art. Furthermore, it is alternatively also conceivable that the at least one further clamping element does not have a wedge-like design, that in particular the cross section is constant, preferably with respect to a shape and/or surface area of the at least one further clamping element, when viewed along the main extension axis of the at least one further clamping element. Advantageously, in order to additionally clamp the energy cell which can be arranged in the energy cell receiving region, a clamping force on an energy cell can be adapted in a structurally simple manner by the at least one further clamping element when the energy cell is arranged in the energy cell receiving region.

Furthermore, it is proposed that the clamping unit has at least one clamping element receptacle, preferably the clamping element receptacle already mentioned above, which is in particular different from the energy cell receiving region for the energy cell and is provided to receive at least the further clamping element of the clamping unit in order to clamp the energy cell which can be arranged in the energy cell receiving region in the cell holder element when the energy cell is arranged in the energy cell receiving region, the clamping element receptacle being designed to taper. Preferably, the at least one clamping element receptacle formed as a recess in the cell holder base body is designed to taper starting from a surface of the cell holder base body, in particular an opening of the recess, in the direction of a lowest point of the clamping element receptacle formed as a recess. The clamping element receptacle, which is at least partially delimited by a wall of the cell holder unit, in particular of the cell holder base body, preferably has a rotationally symmetrical cross section. The cross section of the clamping element receptacle preferably extends in a plane parallel to a main extension axis of the clamping element receptacle. It is conceivable that the cross section of the clamping element receptacle is rotationally symmetrical in the narrower sense, wherein the cross section of the clamping element receptacle in particular forms a circle, or that the cross section of the clamping element receptacle is n-fold rotationally symmetrical, preferably at least with respect to rotations about the main extension axis of the clamping element receptacle. Alternatively, it is also conceivable for the at least one clamping element receptacle to be free of a tapering shape. Advantageously, when the energy cell is arranged in the energy cell receiving region, a clamping force on an energy cell for additionally clamping the energy cell which can be arranged in the energy cell receiving region can be adapted in a structurally simple manner by inserting the at least one further clamping element into the clamping element receptacle.

Furthermore, it is proposed that the clamping unit has at least one clamping element receptacle, preferably the clamping element receptacle already mentioned above, which is in particular different from the energy cell receiving region for the energy cell and is provided to receive at least the further clamping element of the clamping unit in order to clamp the energy cell which can be arranged in the energy cell receiving region in the cell holder element when the energy cell is arranged in the energy cell receiving region, the clamping element receptacle being arranged at a distance from the energy cell receiving region or abutting, in particular directly, the energy cell receiving region. In the case of a design of the clamping element receptacle arranged at a distance from the energy cell receiving region, the at least one further clamping element is in particular provided to deform the cell holder unit, in particular the cell holder base body, and particularly preferably the cell holder element, by an arrangement in the clamping element receptacle such that, when the energy cell is arranged in the energy cell receiving region, a clamping force can be generated on the energy cell which can be arranged in the energy cell receiving region. In the case of a design of the clamping element receptacle preferably directly abutting the energy cell receiving region, the at least one further clamping element is provided to generate, when the energy cell is arranged in the energy cell receiving region, a clamping force directly on the energy cell which can be arranged in the energy cell receiving region by an arrangement in the clamping element receptacle. Advantageously, in particular depending on requirements, particularly compact additional clamping of the energy cell by means of the at least one further clamping element or particularly energy cell-conserving additional clamping of the energy cell can be realized by means of the at least one further clamping element.

It is furthermore proposed that the energy cell holding device comprises a housing in which at least the cell holder unit can be arranged, the clamping element being arranged in the energy cell receiving region, and it being possible for the further clamping element to be arranged on a side face, in particular the side face already mentioned above, of the cell holder unit, in particular of the cell holder base body, and the further clamping element being provided to clamp the energy cell which can be arranged in the energy cell receiving region to the cell holder element when the energy cell is arranged in the energy cell receiving region, as a result of the housing of the energy cell holding device being closed. In particular, the further clamping element is provided to transmit a force that can be generated on the further clamping element by closing the housing of the energy cell holding device to the cell holder unit, preferably in order to deform the cell holder unit, preferably the cell holder base body, and particularly preferably the cell holder element, in order to generate a clamping force on the energy cell which can be arranged in the energy cell receiving region when the energy cell is arranged in the energy cell receiving region. Alternatively, for example, in particular in an exemplary embodiment in which the further clamping element is arranged on the side face of the cell holder unit, it is conceivable for the clamping unit to be free of clamping element receptacles formed, preferably by recesses, in the cell holder unit, in particular in the cell holder base body, in particular for receiving further clamping elements designed to be bolt-shaped or the like. Furthermore, it is also conceivable, for example, for the clamping unit to have at least the one clamping element, which is in particular arranged on, preferably in, the energy cell receiving region, at least the one further clamping element, which can in particular be arranged in the at least one clamping element receptacle and is bolt-shaped or the like, and at least one additional clamping element, which can be arranged on the side face of the cell holder unit, in particular of the cell holder base body, is preferably plate-shaped or the like, and is provided to additionally clamp the energy cell which can be arranged in the energy cell receiving region to the cell holder element when the energy cell is arranged in the energy cell receiving region, as a result of the housing of the energy cell holding device being closed. Particularly reliable clamping of energy cells, in particular also of energy cells that have, for example, manufacturing-related dimensional variations, can advantageously be achieved.

Furthermore, it is proposed that the cell holder unit is designed such that the energy cell receiving region can be enlarged by means of applying heat. Preferably, the cell holder unit, in particular the cell holder base body, preferably the cell holder element, is designed such that the energy cell receiving region can be enlarged by means of applying heat in order to introduce the at least one energy cell into the energy cell receiving region. The at least one clamping element is preferably designed to be enlargeable by means of applying heat in order to introduce the at least one energy cell into the energy cell receiving region. Preferably, the cell holder unit, in particular the cell holder base body, preferably the cell holder element, is provided to be softened and expanded by applying heat in order to enable the at least one energy cell to be introduced into the energy cell receiving region. Preferably, the cell holder unit, in particular the cell holder base body, preferably the cell holder element, is provided for cooling after the energy cell has been introduced, enabled by applying heat to the cell holder unit, in particular to the cell holder base body, preferably to the cell holder element, into the energy cell receiving region and to thereby contract, whereby a clamping force on the energy cell can be generated preferably by means of the clamping unit, in particular the clamping element, when the energy cell is arranged in the energy cell receiving region. The application of heat, preferably for enlarging the cell holder unit, in particular the cell holder base body, preferably the cell holder element, can be generated, for example, by means of a hot air blower, an oven or the like. Particularly flexible and reliable clamping of energy cells of different dimensions can advantageously take place. Advantageously, a particularly accurately fitting mounting of the energy cells can be achieved.

Furthermore, a rechargeable battery pack, in particular the rechargeable battery pack already mentioned above, comprising at least one energy cell, comprising a rechargeable battery pack housing, wherein the rechargeable battery pack housing has a mechanical and/or electrical interface for detachably connecting to a consumer unit, and comprising at least one energy cell holding device according to the disclosure is proposed. The consumer unit can, for example, be designed as a hand-held power tool, as an e-bike, as a lamp, in particular a construction site light, as a radio, in particular a construction site radio, or as another consumer that appears expedient to a person skilled in the art. The rechargeable battery pack housing preferably corresponds to the housing of the energy cell holding device. Advantageously, a rechargeable battery pack with particularly reliable and flexible energy-cell clamping can be provided.

It is moreover proposed that, in the energy cell receiving region, the energy cell is clamped by means of three clamping points when viewed in a cross section, at least one clamping point of the three clamping points being different from the at least one clamping element. The at least one energy cell receiving region preferably has a main extension axis. The main extension axis of the energy cell receiving region preferably extends at least substantially in parallel with the main extension axis of the at least one energy cell when the at least one energy cell is arranged in the energy cell receiving region. The cross section preferably extends in a plane which extends perpendicularly to the main extension axis of the energy cell receiving region. In particular, in at least one exemplary embodiment, the clamping unit has the at least two clamping elements, wherein one of the two clamping elements in each case forms a clamping point of the three clamping points. The clamping point of the three clamping points that is different from the clamping element, in particular the at least two clamping elements, is preferably formed by a face of the cell holder element that at least partially delimits the energy cell receiving region and is different from the at least one clamping element, in particular the at least two clamping elements. The energy cell preferably abuts at least the three clamping points, preferably only the three clamping points, when it is arranged in the energy cell receiving region. The three clamping points are particularly preferably arranged relative to one another such that the three clamping points form corner points of an imaginary isosceles triangle. Advantageously, friction when inserting the energy cells into the energy cell receiving region can be kept low. Advantageously, an energy cell can be fixed particularly easily and reliably in the energy cell receiving region. A particularly high degree of mounting convenience for a particularly secure fixing of the energy cell can advantageously be achieved. By means of the three clamping points, a particularly advantageous force distribution can be achieved, in particular in the case of an external force application by impacts or the like. Undesired deformation of the cell holder unit and/or the energy cells can advantageously be counteracted particularly easily and effectively. Advantageously, damage to the energy cells and/or the cell holder unit can be counteracted.

Furthermore, it is proposed that the further clamping element is formed by the rechargeable battery pack housing, in particular by an external housing part, preferably by a rechargeable battery pack housing bottom of the rechargeable battery pack housing. Alternatively, it is also conceivable that the further clamping element is formed by a rechargeable battery pack housing cover of the rechargeable battery pack housing or by another housing part of the rechargeable battery pack housing that appears expedient to a person skilled in the art. Preferably, the further clamping element formed by the rechargeable battery pack housing, in particular the external housing part, preferably the rechargeable battery pack housing bottom, is provided to clamp the energy cell which can be arranged in the energy cell receiving region to the cell holder element when the energy cell is arranged in the energy cell receiving region, as a result of the rechargeable battery pack housing being closed. In particular, the further clamping element formed by the rechargeable battery pack housing, preferably the external housing part, preferably the rechargeable battery pack housing bottom, is provided to transmit a force that can be generated by closing the rechargeable battery pack housing to the cell holder unit, preferably in order to deform the cell holder unit, preferably the cell holder base body, and particularly preferably the cell holder element, in order to generate a clamping force on the energy cell which can be arranged in the energy cell receiving region when the energy cell is arranged in the energy cell receiving region. A reliable and flexible clamping can advantageously be realized particularly easily and cost-effectively. Advantageously, already existing components of the rechargeable battery pack can be used to additionally clamp the energy cells. Advantageously, a rechargeable battery pack with flexible and reliable clamping can be realized with a particularly small number of components.

The disclosure furthermore relates to a system comprising a rechargeable battery pack having an energy cell holding device according to the disclosure and a further rechargeable battery pack having an energy cell holding device for an energy storage device, in particular the further rechargeable battery pack, which comprises at least one cell holder unit for receiving at least one energy cell, wherein the cell holder unit has at least one cell holder element which at least partially delimits at least one energy cell receiving region, in particular a single energy cell receptacle, for the energy cell, and wherein the energy cell holding device of the further rechargeable battery pack comprises at least one clamping unit which comprises at least one clamping element provided for clamping the energy cell which can be arranged in the energy cell receiving region in the cell holder element when the energy cell is arranged in the energy cell receiving region. It is proposed that the cell holder unit of the energy cell holding device of the rechargeable battery pack and the cell holder unit of the energy cell holding device of the further rechargeable battery pack as well as the clamping element of the clamping unit of the rechargeable battery pack and the clamping element of the clamping unit of the further rechargeable battery pack are designed to be at least substantially identical. Two objects being “at least substantially identical” can in particular be understood to mean that the two objects are designed to be identical except for manufacturing-related dimensional variations. In particular, the energy cell holding device of the rechargeable battery pack and the energy cell holding device of the further rechargeable battery pack differ at least in one element. Alternatively, it is, however, also conceivable for the energy cell holding device of the rechargeable battery pack and the energy cell holding device of the further rechargeable battery pack to be completely identical. Preferably, the clamping unit of the energy cell holding device of the further rechargeable battery pack is free of further clamping elements, in particular designed to be bolt-shaped or the like. Preferably, the clamping unit of the energy cell holding device of the rechargeable battery pack and the clamping unit of the energy cell holding device of the further rechargeable battery pack each have at least one clamping element receptacle, in particular the clamping element receptacle already mentioned above, which is provided to receive at least one clamping element, in particular at least the further clamping element, which is preferably bolt-shaped or the like. Preferably, the rechargeable battery pack and the further rechargeable battery pack are provided to receive an identical number of energy cells. It is conceivable that the energy cells of the rechargeable battery pack and of the further rechargeable battery pack differ in capacity. It is also conceivable for the energy cells of the rechargeable battery pack and of the further rechargeable battery pack to have an identical capacity, wherein the energy cells of the rechargeable battery pack and of the further rechargeable battery pack have, for example, manufacturing-related dimensional differences relative to one another. Advantageously, an energy cell holding device can be provided which can be used for reliable and flexible clamping of the energy cells in rechargeable battery packs comprising different energy cells. A cell holder unit can advantageously be used for different energy cells thanks to the design according to the disclosure of the clamping unit. Production costs can advantageously be reduced.

The energy cell holding device according to the disclosure, the rechargeable battery pack according to the disclosure and/or the system according to the disclosure should not be limited to the use and embodiment described above. In particular, in order to fulfill a functionality described herein, the energy cell holding device according to the disclosure, the rechargeable battery pack according to the disclosure and/or the system according to the disclosure can have a number of individual elements, components and units that deviates from the number mentioned herein. In addition, in the case of the value ranges specified in this disclosure, values within the mentioned limits are also to be considered as disclosed and usable as desired.

### BRIEF DESCRIPTION OF THE DRAWINGS

Further advantages result from the following description of the drawings. Four exemplary embodiments of the disclosure are illustrated in the drawing. The drawing, the description and the claims contain numerous features in combination. A person skilled in the art will expediently also consider the features individually and combine them to form meaningful further combinations.

In the drawings:

FIG. 1 is a schematic sectional view of a system according to the disclosure comprising a rechargeable battery pack according to the disclosure and a further rechargeable battery pack,

FIG. 2 is a sectional view through a part of the rechargeable battery pack according to the disclosure comprising an energy cell holding device according to the disclosure,

FIG. 3 is a schematic sectional view of a rechargeable battery pack according to the disclosure comprising an energy cell holding device according to the disclosure, in a first alternative embodiment,

FIG. 4 is a schematic sectional view of a rechargeable battery pack according to the disclosure comprising an energy cell holding device according to the disclosure, in a second alternative embodiment,

FIG. 5 is a schematic sectional view of a rechargeable battery pack according to the disclosure comprising an energy cell holding device according to the disclosure, in a third alternative embodiment,

FIG. 6 is a schematic sectional view of the energy cell holding device according to the disclosure, in the third alternative embodiment, and

FIG. 7 is a further schematic view of the energy cell holding device according to the disclosure, in the third alternative embodiment.

### DETAILED DESCRIPTION

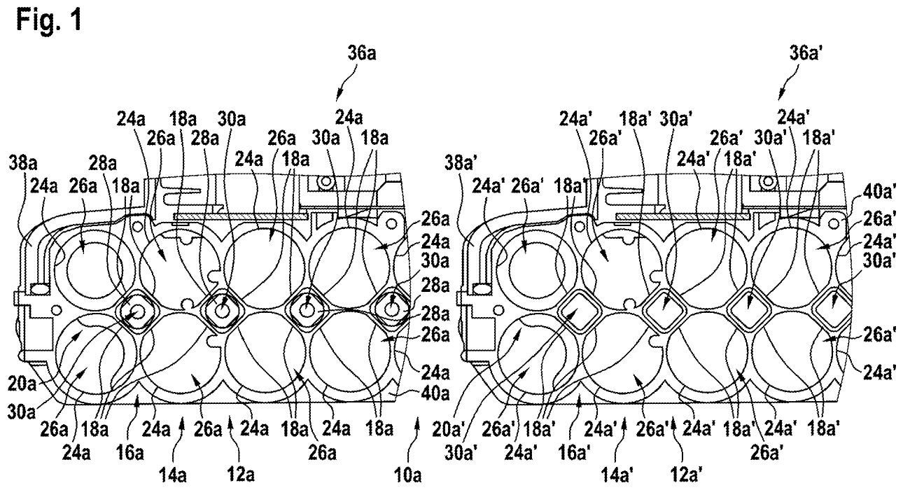

FIG. 1 shows a system 10a comprising a rechargeable battery pack 12a with an energy cell holding device 14a for an energy storage device, in particular for the rechargeable battery pack 12a, and a further rechargeable battery pack 12a′ with an energy cell holding device 14a′. The rechargeable battery pack 12a comprises at least one rechargeable battery pack housing 38a. The rechargeable battery pack housing 38a has a mechanical and/or electrical interface 36a for detachably connecting to a consumer unit. The consumer unit can, for example, be designed as a hand-held power tool, as an e-bike, as a lamp, in particular a construction site light, as a radio, in particular a construction site radio, or as another consumer that appears expedient to a person skilled in the art. The rechargeable battery pack 12a and the further rechargeable battery pack 12a′ each have a plurality of energy cells 22a. The plurality of energy cells 22a of the rechargeable battery pack 12a and of the further rechargeable battery pack 12a′ are arranged in two layers. The energy cells 22a are designed as rechargeable battery cells. Alternatively, it is, however, also conceivable that the energy cells 22a are designed as primary cells or other energy cells 22a that appear expedient to a person skilled in the art. The energy cells 22a each have a main extension axis. The energy cells 22a are each rotationally symmetrical, in particular with respect to rotations about the main extension axis of the respective energy cell 22a. The energy cells 22a are circular cylindrical. Alternatively, it is, however, also conceivable for the energy cells 22a to be flat or spherical or to have another shape that appears expedient to a person skilled in the art.

The energy cell holding device 14a comprises at least one cell holder unit 16a for receiving the plurality of energy cells 22a of the rechargeable battery pack 12a. Alternatively, it is also conceivable for the cell holder unit 16a to be provided to receive only one energy cell 22a. The cell holder unit 16a has at least a plurality of cell holder elements 24a, each at least partially delimiting at least one energy cell receiving region 26a, in particular a single energy cell receptacle, for a respective energy cell 22a of the plurality of energy cells 22a. The plurality of cell holder elements 24a form a honeycomb-like structure. Alternatively, it is also conceivable for the cell holder unit 16a to have only one cell holder element 24a.

The plurality of cell holder elements 24a are arranged on a cell holder base body 40a of the cell holder unit 16a, in particular formed in one piece with the cell holder base body 40a. Particularly preferably, the plurality of cell holder elements 24a are formed by the cell holder base body 40a. Alternatively, it is, however, also conceivable that the plurality of cell holder elements 24a can be arranged detachably, in particular detachably in a non-destructive manner, on the cell holder base body 40a. The cell holder base body 40a is formed in one piece. However, it is alternatively also conceivable for the cell holder base body 40a to be formed in multiple parts, for example in two parts. The energy cell receiving regions 26a, which are at least partially delimited by a respective one of the plurality of cell holder elements 24a, are each designed as a single energy cell receptacle. The at least one cell holder element 24a, in particular the energy cell receiving region 26a, is preferably formed by a recess in the cell holder unit 16a, in particular in the cell holder base body 40a. The energy cell receiving region 26a is designed as a receiving shaft for at least one of the energy cells 22a, into which shaft the at least one energy cell 22a can be introduced, in particular inserted. The energy cell receiving regions 26a designed as single energy cell receptacles are each provided to receive a single energy cell 22a of the plurality of energy cells 22a. Alternatively, it is, however, also conceivable for the energy cell receiving regions 26a to each be provided to receive at least two energy cells 22a of the plurality of energy cells 22a. The plurality of cell holder elements 24a, preferably the cell holder base body 40a, are/is preferably formed at least substantially completely from an elastic, in particular rubber-elastic, material. Alternatively, it is, however, also conceivable for the plurality of cell holder elements 24a, in particular the cell holder base body 40a, to be formed at least substantially completely free of an elastic, in particular rubber-elastic, material.

The energy cell holding device 14a comprises at least one clamping unit 20a. The clamping unit 20a is different from electrical contact elements of the rechargeable battery pack 12a, which are provided for electrically contacting the energy cells 22a. The clamping unit 20a is provided to respectively clamp the plurality of energy cells 22a in at least two different ways, in particular in at least two successive steps, to one of the plurality of cell holder elements 24a. The clamping unit 20a comprises a plurality of clamping elements 18a. In the following, the plurality of clamping elements 18a are described by way of example with reference to a single clamping element 18a of the plurality of clamping elements 18a. The at least one clamping element 18a is provided to clamp an energy cell 22a of the plurality of energy cells 22a which can be arranged in the energy cell receiving region 26a of a cell holder element 24a of the plurality of cell holder elements 24a in the cell holder element 24a when the energy cell 22a is arranged in the energy cell receiving region 26a. The at least one clamping element 18a is provided to at least partially clamp, in particular pre-fix, the energy cell 22a on, preferably in, the cell holder element 24a, with a clamping force.

The clamping unit 20a has a plurality of further clamping elements 28a, which are designed to additionally clamp the plurality of energy cells 22a which can be arranged in the respective energy cell receiving region 26a. In the following, the plurality of further clamping elements 28a are described by way of example with reference to a single further clamping element 28a of the plurality of further clamping elements 28a. The further clamping element 28a is provided to exert an additional clamping force on the energy cell 22a, which is in particular already at least partially clamped, in particular pre-fixed, to the cell holder element 24a by means of the clamping element 18a, in order to additionally clamp the energy cell 22a to the cell holder element 24a. A clamping force that can be generated by means of the clamping element 18a is smaller than a clamping force that can be generated by means of the further clamping element 28a. Alternatively, it is, however, also conceivable that a clamping force that can be generated by means of the clamping element 18a is greater than a clamping force that can be generated by means of the further clamping element 28a or that a clamping force that can be generated by means of the clamping element 18a is equal to a clamping force that can be generated by means of the further clamping element 28a. Alternatively it is, however, also conceivable that the clamping unit 20a is provided to clamp the energy cell 22a to the cell holder element 24a only in one way, in particular to completely clamp it by means of the clamping element 18a or the further clamping element 28a. The at least one clamping element 18a is arranged on the cell holder element 24a. The clamping element 18a is formed by the cell holder element 24a. Alternatively, it is, however, also conceivable for the clamping element 18a to be formed separately from the cell holder element 24a. The clamping element 18a is designed as an elastic, in particular rubbery-elastic, element. It is conceivable that at least two clamping elements 18a are arranged on the cell holder element 24a, in particular are formed in one piece therewith. The clamping element 18a is arranged on, preferably in, the energy cell receiving region 26a such that the clamping element 18a is arranged at least partially, preferably at least substantially completely, within the energy cell receiving region 26a. The at least one clamping element 18a is arranged on, in particular in, the energy cell receiving region 26a such that the energy cell 22a can be arranged in the energy cell receiving region 26a only by deformation of the clamping element 18a and/or of the cell holder unit 16a, in particular of a cell holder base body 40a of the cell holder unit 16a, preferably of the cell holder element 24a. The clamping element 18a is web-like. Alternatively, it is, however, also conceivable for the clamping element 18a to be knob-like or polygonal or to have another shape that appears expedient to a person skilled in the art. The energy cell 22a with the cell holder element 24a can preferably be clamped to the cell holder element 24a by a restoring force that can be generated by deformation of the clamping element 18a and/or of the cell holder unit 16a, in particular of the cell holder base body 40a, preferably of the cell holder element 24a, when the energy cell 22a is being arranged in the energy cell receiving region 26a. A restoring force, which acts as a clamping force on the energy cell 22a, can be generated by deformation of the elastic, in particular rubbery-elastic, clamping element 18a, which deformation can be generated as a result of the energy cell 22a being inserted into the energy cell receiving region 16a. It is conceivable that the at least one clamping element 18a is arranged on, in particular in, the energy cell receiving region 26a such that the energy cell 22a can be arranged in the energy cell receiving region 26a by deformation of the clamping element 18a and/or by a displacement, in particular a purely linear displacement, of the clamping element 18a. Alternatively or additionally, it is conceivable that the at least one clamping element 18a is arranged on, in particular in, the energy cell receiving region 26a such that the energy cell 22a can be arranged in the energy cell receiving region 26a by deformation of the cell holder unit 16a, in particular of a cell holder base body 40a of the cell holder unit 16a, preferably of the cell holder element 24a. Alternatively, it is conceivable, for example, for the clamping unit 20a to comprise at least one spring element, which is provided to preload the at least one clamping element 18a. In particular, the at least one clamping element is preloaded and/or arranged by means of the at least one spring element such that by inserting the energy cell 22a into the energy cell receiving region 26a, the clamping element 18a can be displaced against a restoring force that can be generated by the spring element, preferably in order to exert a clamping force on the energy cell 22a. The spring element can be designed, for example, as a spiral spring, a leaf spring, a wave spring, a torsion spring, a compression spring, a conical spring, a barrel spring or another spring element that appears expedient to a person skilled in the art.

The further clamping element 28a is designed to be different from the clamping element 18a. The plurality of further clamping elements 28a may, for example, be designed to be at least partially identical to one another or at least partially different from one another. It is conceivable that the further clamping element 28a is formed from an elastic, in particular rubbery-elastic, material. The at least one further clamping element 28a is bolt-shaped. Alternatively, it is also conceivable for the at least one further clamping element 28a to be of pin-shaped, wedge-shaped, plate-shaped, cubic, spherical, ramp-shaped design or to have another design that appears expedient to a person skilled in the art.

In order to generate a clamping force on the energy cell 22a, the at least one further clamping element 28a is provided to deform the at least one cell holder element 24a, in particular the cell holder base body 40a, in order to clamp the energy cell 22a in the cell holder element 24a. Alternatively or additionally, it is also conceivable for the at least one further clamping element 28a to be provided to generate a clamping force directly on the energy cell 22a in order to clamp the energy cell 22a in the cell holder element 24a. The clamping element 18a is provided to exert a clamping force on the energy cell 22a that is directed onto the energy cell 22a transversely, in particular perpendicularly, particularly preferably radially, relative to the main extension axis of the energy cell 22a. The further clamping element 28a is provided to exert a clamping force on the energy cell 22a that is directed onto the energy cell 22a transversely, in particular perpendicularly, particularly preferably radially, relative to the main extension axis of the energy cell 22a.

The at least one further clamping element 28a is rotationally symmetrical. The at least one further clamping element 28a is wedge-like. The at least one further clamping element 28a has a conical shape. When viewed in parallel with the main extension axis of the further clamping element 28a, the at least one further clamping element 28a is wedge-like. The wedge-like further clamping element 28a is designed to taper off. The further clamping element 28a is conical. The further clamping element 28a has the shape of a truncated cone. Alternatively, it is also conceivable for the at least one further clamping element 28a to have a circular cylindrical shape, to be pyramidal or to have another shape that appears expedient to a person skilled in the art, for a further clamping element 28a. The at least one further clamping element 18a has a circular cross section. Alternatively, it is also conceivable that the at least one further clamping element 18a has a polygonal cross section or another cross section that appears expedient to a person skilled in the art. The cross section of the further clamping element 28a extends in a plane perpendicular to a main extension axis of the further clamping element 28a. The cross section of the further clamping element 28a is preferably rotationally symmetrical, in particular with respect to the main extension axis of the further clamping element 28a. The further clamping element 28a is rotationally symmetrical in the narrower sense, in particular with respect to rotations about the main extension axis of the further clamping element 28a. The further clamping element 28a, which is rotationally symmetrical in the narrower sense, is designed such that the further clamping element 28a maps onto itself as it rotates by any angle about the main extension axis. Alternatively, it is also conceivable that the further clamping element 28a, in particular the cross section of the further clamping element 28a, has an n-fold rotational symmetry. n may be a natural number greater than 1. The n-fold rotationally symmetrical further clamping element 28a maps onto itself in particular as it rotates by an angle α=360°/n about the main extension axis of the further clamping element 28a. For example, the cross section of the n-fold rotationally symmetrical further clamping element 28a forms a triangle, a square, a pentagon, a hexagon, or another n-fold rotationally symmetrical geometric figure that appears expedient to a person skilled in the art.

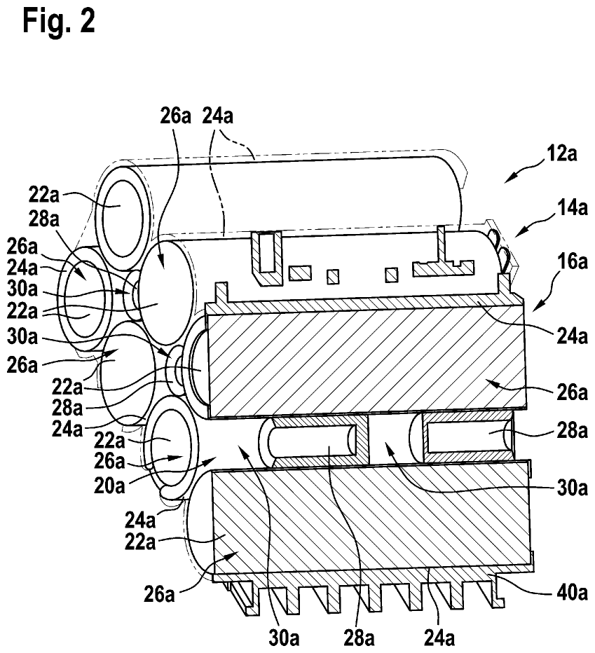

In order to additionally clamp the energy cell 22a which can be arranged in the energy cell receiving region 26a, the at least one further clamping element 28a can be arranged, in particular variably, on the cell holder unit 16a when the energy cell 22a is arranged in the energy cell receiving region 26a. The at least one further clamping element 28a is formed separately from the cell holder unit 16a, in particular at least separately from the at least one cell holder element 24a and/or the cell holder base body 40a. In order to additionally clamp the energy cell 22a which can be arranged in the energy cell receiving region 26a, the at least one further clamping element 28a is provided to be attached to the cell holder unit 16a, in particular to the cell holder base body 40a, when the energy cell 22a is arranged in the energy cell receiving region 26a. The clamping unit 20a has at least a plurality of clamping element receptacles 30a, to, preferably in, which at least one of the plurality of further clamping elements 28a can respectively be attached when the energy cell 22a is arranged in the energy cell receiving region 26a in order to additionally clamp the energy cell 22a which can be arranged in the energy cell receiving region 26a. The clamping element receptacles 30a are arranged on at least two sides of the cell holder base body 40a facing away from one another (cf. FIG. 2). Alternatively, it is also conceivable that clamping element receptacles 30a are arranged only on one side of the cell holder base body 40a. The clamping element receptacles 30a are different from the energy cell receiving regions 26a. Alternatively, it is also conceivable for the clamping unit 20a to have only one clamping element receptacle 30a. The plurality of clamping element receptacles 30a are formed as recesses, in particular as receiving shafts for the plurality of further clamping elements 28a, in the cell holder base body 40a. The clamping element receptacles 30a are arranged between the energy cell receiving regions 26a. The plurality of clamping element receptacles 30a are arranged at a distance from one another. The plurality of clamping element receptacles 30a are designed to be at least substantially identical. Alternatively, it is, however, also conceivable for the plurality of clamping element receptacles 30a to be at least partially different.

The clamping element receptacles 30a are each designed to taper. The clamping element receptacles 30a are each designed to taper starting from a surface of the cell holder base body 40a in the direction of a lowest point of the respective clamping element receptacle 30a. The clamping element receptacles 30a, which are respectively at least partially delimited by a wall of the cell holder unit 16a, in particular of the cell holder base body 40a, have a rotationally symmetrical cross section. The respective cross section of the clamping element receptacles 30a extends in a plane parallel to a main extension axis of the respective clamping element receptacle 30a. The cross section of the clamping element receptacles 30a is respectively rotationally symmetrical in the narrower sense, wherein the cross section of the clamping element receptacles 30a respectively forms a circle. Alternatively, it is conceivable that the cross sections of the clamping element receptacles 30a are at least partially n-fold rotationally symmetrical, in particular at least with respect to rotations about the respective main extension axis of the clamping element receptacles 30a. Alternatively, it is also conceivable for the clamping element receptacles 30a to be at least partially free of a tapering shape.

The clamping unit 20a is designed such that a clamping force on the at least one energy cell 22a which can be arranged in the energy cell receiving region 26a can be adjusted when the energy cell 22a is arranged in the energy cell receiving region 26a by arranging the at least one further clamping element 28a relative to the energy cell receiving region 26a. A clamping force on the energy cell 22a which can be arranged in the energy cell receiving region 26a can be adjusted when the energy cell 22a is arranged in the energy cell receiving region 26a by variably arranging the further clamping element 28a on, preferably in, the clamping element receptacle 30a. It is also conceivable that a clamping force on the energy cell 22a which can be arranged in the energy cell receiving region 26a is dependent, when the energy cell 22a is arranged in the energy cell receiving region 26a, on which of the plurality of clamping element receptacles 30a further clamping elements 28a are arranged on, preferably in.

In order to additionally clamp the energy cell 22a which can be arranged in the energy cell receiving region 26a, the further clamping element 28a can be inserted into the cell holder unit 16a when the energy cell 22a is arranged in the energy cell receiving region 26a. In order to additionally clamp the energy cell 22a which can be arranged in the energy cell receiving region 26a, the at least one further clamping element 28a can be inserted, when the energy cell 22a is arranged in the energy cell receiving region 26a, into the clamping element receptacle 30a formed as a recess in the cell holder base body 40a. The further clamping element 28a is provided to deform the cell holder unit 16a, in particular the cell holder base body 40a, and preferably the cell holder element 24a, as a result of inserting the further clamping element 28a into the cell holder unit 16a, in particular into the clamping element receptacle 30a. The further clamping element 28a can be inserted into the cell holder unit 16a, preferably into the cell holder base body 40a, preferably into the clamping element receptacle 30a, such that, as a result of the deformation generated thereby of the cell holder unit 16a, in particular of the cell holder base body 40a, and particularly preferably of the at least one cell holder element 24a, when the energy cell 22a is arranged in the energy cell receiving region 26a, a clamping force can be generated on the energy cell 22a which can be arranged in the energy cell receiving region 26a. The clamping element receptacle 30a is arranged at a distance from the energy cell receiving region 26a.

A clamping force acting on the energy cell 22a can be adjusted via an insertion depth of the at least one further clamping element 28a relative to the cell holder unit 16a. A deformation of the cell holder base body 40a, in particular of the cell holder element 24a, and thus a clamping force on the energy cell 22a which can be arranged in the energy cell receiving region 26a is dependent, when the energy cell 22a is arranged in the energy cell receiving region 26a, on an insertion depth of the at least one further clamping element 18a relative to the cell holder unit 16a, in particular relative to the cell holder base body 40a, preferably relative to the clamping element receptacle 30a. A deformation of the cell holder base body 40a, in particular of the cell holder element 24a, and thus also a clamping force on the energy cell 22a which can be arranged in the energy cell receiving region 26a can be increased when the energy cell 22a is arranged in the energy cell receiving region 26a by a deeper insertion of the further clamping element 28a relative to the cell holder unit 16a, in particular the clamping element receptacle 30a.

Alternatively, it is, however, also conceivable for the clamping element receptacle 30a to abut, in particular directly, the energy cell receiving region 26a. In particular, the clamping element receptacle 30a is alternatively arranged relative to the energy cell receiving region 26a such that the at least one further clamping element 28a can be inserted into the cell holder unit 16a, preferably into the cell holder base body 40a, preferably into the clamping element receptacle 30a, such that, when the energy cell 22a is arranged in the energy cell receiving region 26a, the at least one further clamping element 28a directly abuts the energy cell 22a which can be arranged in the energy cell receiving region 26a, and a clamping force can be generated directly on the energy cell 22a by the further clamping element 28a.

The energy cell holding device 14a′ comprises at least one cell holder unit 16a′ for receiving at least one energy cell 22a′. The cell holder unit 16a′ has at least one cell holder element 24a′, which at least partially delimits at least one energy cell receiving region 26a′, in particular a single energy cell receptacle, for the energy cell 22a′. The energy cell holding device 14a′ comprises at least one clamping unit 20a′. The clamping unit 20a′ comprises at least one clamping element 18a′ provided for clamping the energy cell 22a′ which can be arranged in the energy cell receiving region 26a′ in the cell holder element 24a′ when the energy cell 22a′ is arranged in the energy cell receiving region 26a′. The cell holder unit 16a and the cell holder unit 16a′ as well as the clamping element 18a and the clamping element 18a′ are designed to be at least substantially identical. The clamping unit 20a′ is free of further clamping elements 28a designed to be bolt-shaped or the like, wherein the clamping unit 20a′ has clamping element receptacles 30a′ for receiving further clamping elements 28a designed to be bolt-shaped or the like. The rechargeable battery pack 12a and the further rechargeable battery pack 12a′ are provided to receive an identical number of energy cells 22a. It is conceivable that the energy cells 22a of the rechargeable battery pack 12a and of the further rechargeable battery pack 12a′ differ in capacity. It is also conceivable for the energy cells 22a of the rechargeable battery pack 12a and of the further rechargeable battery pack 12a′ to have an identical capacity, wherein the energy cells 22a of the rechargeable battery pack 12a and of the further rechargeable battery pack 12a′ have, for example, manufacturing-related dimensional differences relative to one another.

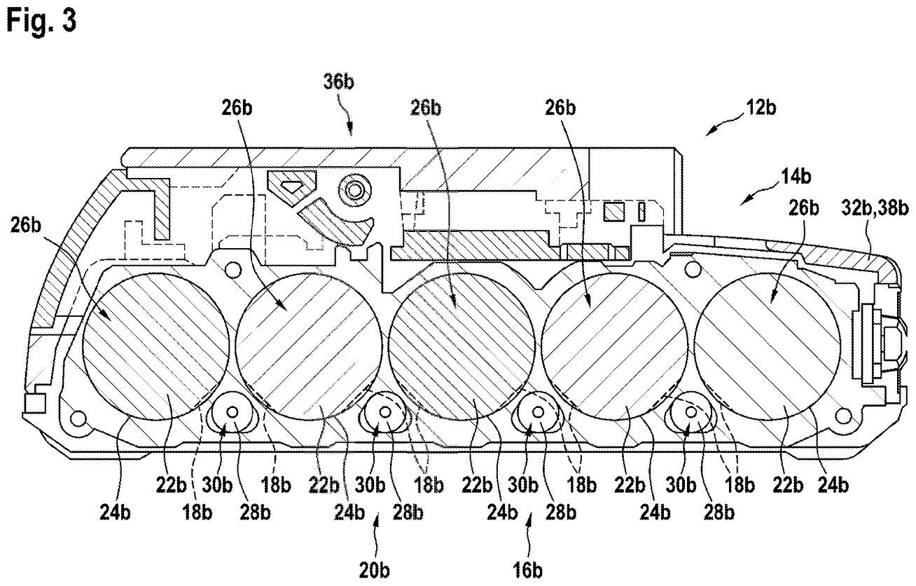

FIGS. 3 to 7 show three further exemplary embodiments of the disclosure. The following descriptions and the drawings are substantially limited to the differences between the exemplary embodiments, wherein reference can basically also be made to the drawings and/or the description of the other exemplary embodiments, in particular of FIGS. 1 and 2, with respect to identically designated components, in particular with respect to components having the same reference signs. In order to distinguish the exemplary embodiments, the letter a is added to the reference signs of the exemplary embodiment in FIGS. 1 and 2. In the exemplary embodiments of FIGS. 3 to 7, the letter a is replaced by the letters b, c, and d.

FIG. 3 shows a rechargeable battery pack 12b with an energy cell holding device 14b. The rechargeable battery pack 12b comprises at least one rechargeable battery pack housing 38b. The rechargeable battery pack housing 38b has a mechanical and/or electrical interface 36b for detachably connecting to a consumer unit. The rechargeable battery pack 12b has a plurality of energy cells 22b. The plurality of energy cells 22b of the rechargeable battery pack 12b are arranged in one layer. The energy cell holding device 14b comprises at least one cell holder unit 16b for receiving the plurality of energy cells 22b of the rechargeable battery pack 12b. Alternatively, it is also conceivable for the cell holder unit 16b to be provided to receive only one energy cell 22b. The cell holder unit 16b has at least a plurality of cell holder elements 24b, each at least partially delimiting at least one energy cell receiving region 26b, in particular a single energy cell receptacle, for a respective energy cell 22b of the plurality of energy cells 22b. Alternatively, it is also conceivable for the cell holder unit 16b to have only one cell holder element 24b. The energy cell holding device 14b comprises at least one clamping unit 20b. The clamping unit 20b comprises a plurality of clamping elements 18b provided for clamping the energy cells 22b which can be arranged in the respective energy cell receiving regions 26b in the respective cell holder element 24b when the energy cells 22b are arranged in the respective energy cell receiving region 26b. The clamping unit 20b has a plurality of further clamping elements 28b which are designed to additionally clamp the energy cell 22b which can be arranged in the respective energy cell receiving region 26b. The clamping unit 20b has at least a plurality of clamping element receptacles 30b, to, preferably in, which at least one of the plurality of further clamping elements 28b can respectively be attached when the energy cell 22b is arranged in the energy cell receiving region 26b in order to additionally clamp an energy cell 22b which can be arranged in the energy cell receiving region 26b.

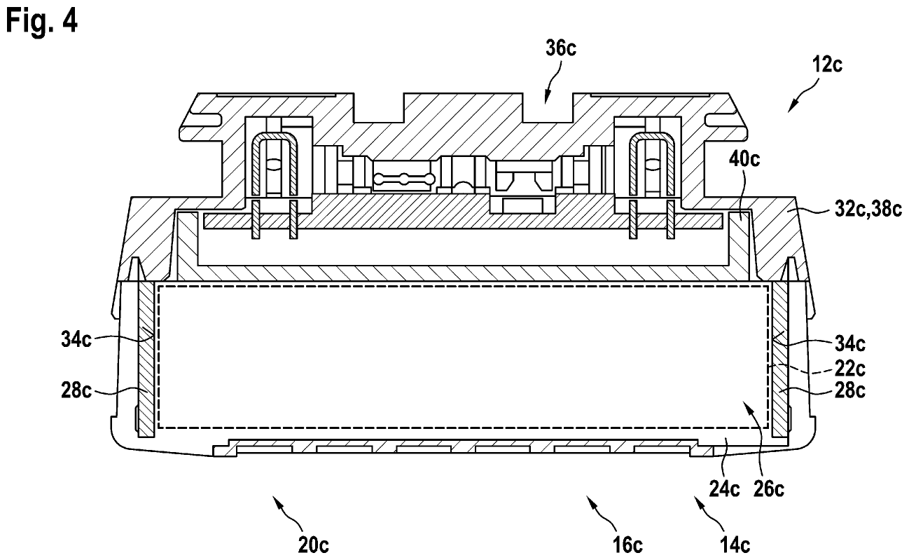

FIG. 4 shows a rechargeable battery pack 12c with an energy cell holding device 14c. The rechargeable battery pack 12c comprises at least one rechargeable battery pack housing 38c. The rechargeable battery pack housing 38c has a mechanical and/or electrical interface 36c for detachably connecting to a consumer unit. The rechargeable battery pack 12c has a plurality of energy cells 22c. The plurality of energy cells 22c of the rechargeable battery pack 12c are arranged in one layer. The energy cell holding device 14c comprises at least one cell holder unit 16c for receiving a plurality of energy cells 22c. The cell holder unit 16c has a plurality of cell holder elements 24c, each at least partially delimiting at least one energy cell receiving region 26c, in particular a single energy cell receptacle, for a respective one of the plurality of energy cells 22c. The energy cell holding device 14c comprises at least one clamping unit 20c. The clamping unit 20c comprises a plurality of clamping elements (not shown here). In the following, the plurality of clamping elements are described by way of example with reference to a single clamping element of the plurality of clamping elements. The at least one clamping element is arranged in the energy cell receiving region 26c. The clamping element is formed by the cell holder element 24c. Alternatively it is, however, also conceivable for the clamping element to be formed separately from the cell holder element 24c. The clamping element is designed as an elastic, in particular rubbery-elastic, element. The clamping element is provided to reduce a cross section of the energy cell receiving region 26c, in particular such that the energy cell 22c can be arranged in the energy cell receiving region 26c only by deformation of the clamping element and/or of the cell holder unit 16c, in particular of a cell holder base body 40c of the cell holder unit 16c, preferably of the cell holder element 24c. The clamping element is web-like. Alternatively, it is, however, also conceivable for the clamping element to be knob-like or polygonal or to have another shape that appears expedient to a person skilled in the art. The energy cell 22c with the cell holder element 24c can be clamped to the cell holder element 24c by a restoring force that can be generated by deformation of the clamping element and/or of the cell holder unit 16c, in particular of the cell holder base body 40c, preferably of the cell holder element 24c, when the energy cell 22c is being arranged in the energy cell receiving region 26c.

The clamping unit 20c has a plurality of, in particular two, further clamping elements 28c, which are designed to additionally clamp the plurality of energy cells 22c which can be arranged in the respective energy cell receiving region 26c. The plurality of further clamping elements 28c can each be arranged on a side face 34c of the cell holder unit 16c. The, in particular two, further clamping elements 28c are arranged on side faces 34c of the cell holder unit 16c facing away from one another. Alternatively, it is, however, also conceivable that only on one of the side faces 34c, at least one of the plurality of further clamping elements 28c is arranged. In the following, the plurality of further clamping elements 28c are described by way of example with reference to a single further clamping element 28c of the plurality of further clamping elements 28c. The energy cell holding device 14c comprises a housing 32c, in which the cell holder unit 16c can be arranged. The further clamping element 28c is provided to clamp the at least one energy cell 22c which can be arranged in the energy cell receiving region 26c to the cell holder element 24c when the energy cell 22c is arranged in the energy cell receiving region 26c, as a result of the housing 32c being closed. The rechargeable battery pack housing 38c of the rechargeable battery pack 12c corresponds to the housing 32c.

The further clamping element 28c is provided to transmit a force, which can be exerted on the further clamping element 28c by closing the housing 32c of the energy cell holding device 14c, to the cell holder unit 16c, preferably in order to deform the cell holder unit 16c, preferably the cell holder base body 40c, and particularly preferably the cell holder element 24c, in order to generate a clamping force on the energy cell 22c which can be arranged in the energy cell receiving region 26c when the energy cell 22c is arranged in the energy cell receiving region 26c. The further clamping element 28c, which can be arranged on the side face 34c of the cell holder unit 16c, in particular on a side face 34c of the cell holder base body 40c, and is in particular formed from an elastic, in particular rubbery-elastic, material, is plate-shaped. Alternatively, it is also conceivable that the further clamping element 28c, which can be arranged on the side face 34c of the cell holder unit 16c, in particular on the side face 34c of the cell holder base body 40c, and is preferably formed from an elastic, in particular rubbery-elastic, material is cubic, spherical or the like. The further clamping element 28c is provided to exert a clamping force on the energy cell 22c that is directed onto the energy cell 22c at least substantially in parallel with a main extension axis of the energy cell 22c.

The clamping unit 20c is designed such that the energy cell receiving region 26c can be enlarged by means of applying heat. The at least one clamping element is designed such that the clamping element can be enlarged by means of applying heat, in particular in order to introduce the at least one energy cell 22c into the energy cell receiving region 26c. The cell holder unit 16c, in particular the cell holder base body 40c, preferably the cell holder element 24c, is provided to be softened and expanded by applying heat in order to enable the at least one energy cell 22c to be introduced into the energy cell receiving region 26c. The cell holder unit 16c, in particular the cell holder base body 40c, preferably the cell holder element 24c, is provided for cooling after the energy cell 22c has been introduced, enabled by applying heat to the cell holder unit 16c, in particular to the cell holder base body 40c, preferably to the cell holder element 24c, into the energy cell receiving region 26c and to thereby contract, whereby a clamping force on the energy cell 22c can be generated preferably by means of the clamping unit 20c, in particular the clamping element, when the energy cell 22c is arranged in the energy cell receiving region 26c. The application of heat, preferably for enlarging the cell holder unit 16c, in particular the cell holder base body 40c, preferably the cell holder element 24c, can be generated, for example, by means of a hot air blower, an oven or the like.

It is conceivable for the clamping unit 20c to be free of clamping element receptacles formed, in particular by recesses in the cell holder unit 16c, preferably in the cell holder base body 40c, for receiving further clamping elements designed to be bolt-shaped or the like. Furthermore, it is alternatively also conceivable, for example, for the clamping unit 20c to have at least the one clamping element, at least the one further clamping element 28c that can be arranged on the side face 34c of the cell holder unit 16c, in particular of the cell holder base body 40c, and to comprise at least one additional clamping element designed to be bolt-shaped or the like.

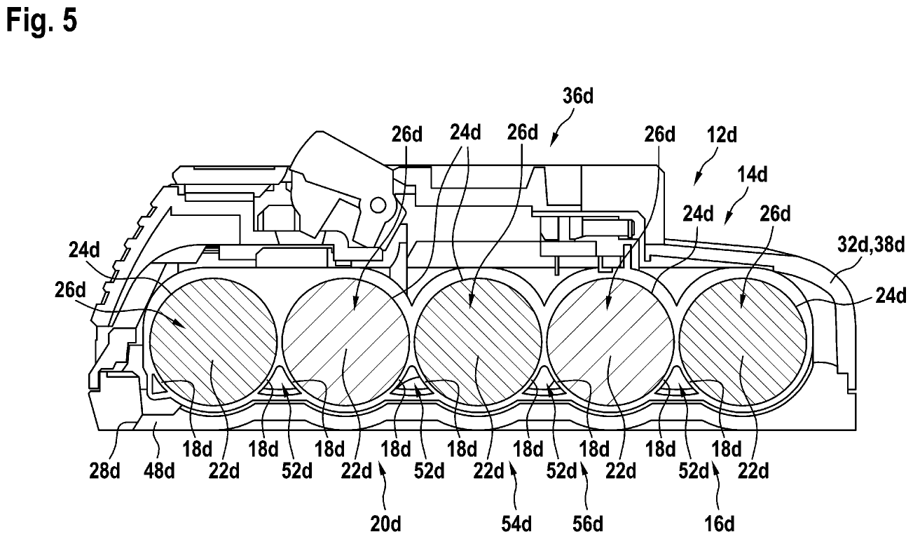

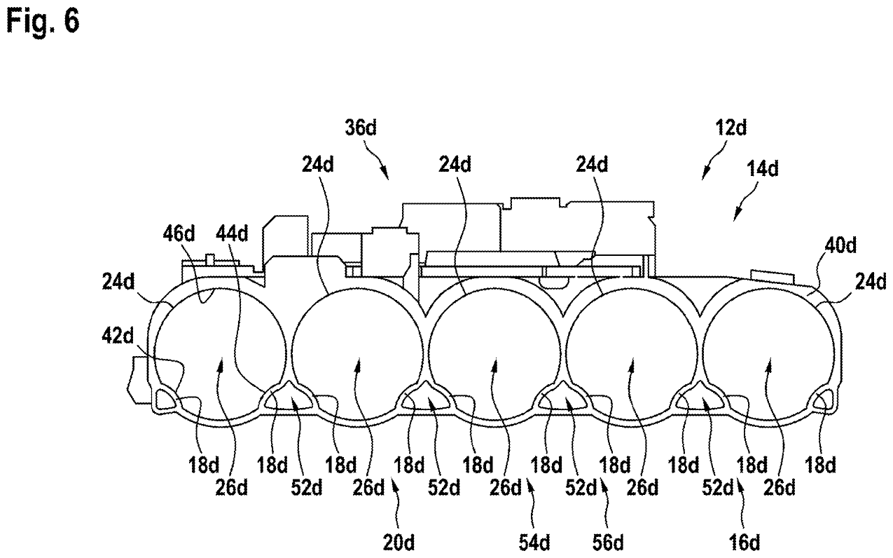

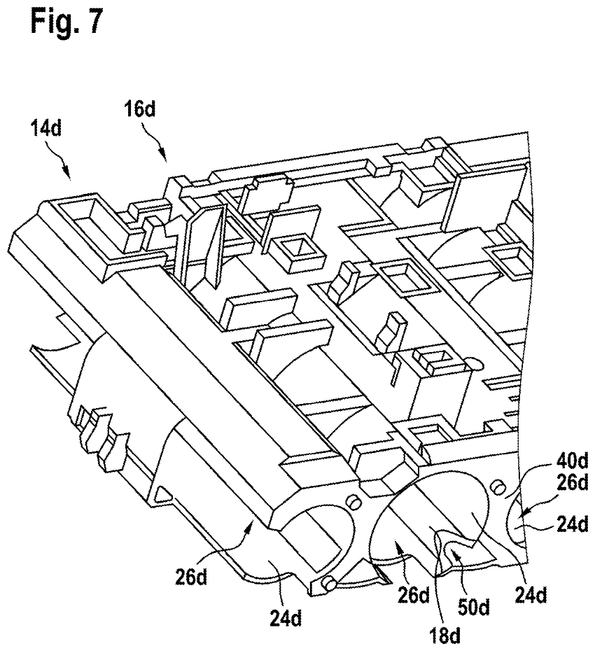

FIG. 5 shows a rechargeable battery pack 12d with an energy cell holding device 14d (cf. also FIGS. 6 and 7). The rechargeable battery pack 12d comprises at least one rechargeable battery pack housing 38d. The rechargeable battery pack housing 38d has a mechanical and/or electrical interface 36d for detachably connecting to a consumer unit. The rechargeable battery pack 12d has a plurality of energy cells 22d. The plurality of energy cells 22d of the rechargeable battery pack 12d are arranged in one layer. The energy cell holding device 14d comprises at least one cell holder unit 16d for receiving the plurality of energy cells 22d of the rechargeable battery pack 12d. Alternatively, it is also conceivable for the cell holder unit 16d to be provided to receive only one energy cell 22d. The cell holder unit 16d has at least a plurality of cell holder elements 24d, each at least partially delimiting at least one energy cell receiving region 26d, in particular a single energy cell receptacle, for a respective energy cell 22d of the plurality of energy cells 22d. Alternatively, it is also conceivable for the cell holder unit 16d to have only one cell holder element 24d.

The energy cell holding device 14d comprises at least one clamping unit 20d. The clamping unit 20d is provided in particular for rechargeable battery packs 12d with energy cells 22d arranged in one layer. The clamping unit 20d comprises a plurality of clamping elements 18d provided for clamping the energy cells 22d which can be arranged in the respective energy cell receiving regions 26d in the respective cell holder element 24d when the energy cells 22d are arranged in the respective energy cell receiving region 26d. Two clamping elements 18d each are arranged in the energy cell receiving regions 26d. When viewed in a cross section, the energy cells 22d are each clamped by means of three clamping points 42d, 44d, 46d. The energy cell receiving regions 26d each have a main extension axis. The respective main extension axis of the energy cell receiving regions 26d extends at least substantially in parallel with a main extension axis of the respective energy cell 22d when the at least one energy cell 22d is arranged in the energy cell receiving region 26d. The cross section extends in a plane perpendicular to a main extension axis of the respective energy cell receiving region 26d. At least one clamping point 46d of the respectively three clamping points 42d, 44d, 46d is different from the two clamping elements 18d, which are arranged in particular in the respective energy cell receiving region 26d. The clamping point 46d of the respectively three clamping points 42d, 44d, 46d is formed by a face of the cell holder element 24d that at least partially delimits the respective energy cell receiving region 26d and is different from the respectively two clamping elements 18d. When viewed in the cross section, the energy cells 22d abut, when the energy cells 22d are arranged in the respective energy cell receiving region 26d, at least each of the three clamping points 42d, 44d, 46d, preferably only each of the three clamping points 42d, 44d, 46d.

The clamping unit 20d has at least one further clamping element 28d which is designed to additionally clamp the energy cells 22d which can be arranged in the energy cell receiving regions 26d. The further clamping element 28d is formed by the rechargeable battery pack housing 38d. The further clamping element 28d is formed by an external housing part of the rechargeable battery pack housing 38d. The further clamping element 28d is formed by a rechargeable battery pack housing bottom 48d of the rechargeable battery pack housing 38d. Alternatively, it is also conceivable that the further clamping element 28d is formed by a rechargeable battery pack housing cover of the rechargeable battery pack housing 38d or by another housing part of the rechargeable battery pack housing 38d that appears expedient to a person skilled in the art. The further clamping element 28d formed by the rechargeable battery pack housing 38d, in particular the rechargeable battery pack housing bottom 48d, is provided to clamp the energy cells 22d which can be arranged in the energy cell receiving regions 26d to the cell holder elements 24d when the energy cells 22d are arranged in the energy cell receiving regions 26d, as a result of the rechargeable battery pack housing 38d being closed. The further clamping element 28d formed by the rechargeable battery pack housing 38d, in particular the rechargeable battery pack housing bottom 48d, is provided to transmit a force which can be generated by closing the rechargeable battery pack housing 38d to the cell holder unit 16d, in order to deform the cell holder unit 16d, preferably the cell holder base body 40d, and particularly preferably the cell holder elements 24d, in order to generate a clamping force on the energy cells 22d which can be arranged in the energy cell receiving regions 26d when the energy cells 22d are arranged in the energy cell receiving regions 22d.

The cell holder unit 16d, in particular the cell holder base body 40d, has a plurality of damping elements 52d. In particular, one of the damping elements 52d is respectively arranged between two cell holder elements 24d in each case. The damping elements 52d are provided at least to damp an external force application, for example by impacts or the like, to the energy cell holding device 14d, in particular the cell holder unit 16d. The damping elements 52d each delimit a recess in the cell holder base body 40d. In particular at least when viewed in a cross section of the cell holder unit 16d, preferably of the cell holder base body 40d, the recesses delimited by the damping elements 52d respectively have a triangular shape, wherein the cross section preferably extends in a plane arranged perpendicularly to the main extension axis of the energy cell receiving regions 26d and/or a main extension axis of the triangular recesses. Alternatively, it is also conceivable that the recesses delimited by the damping elements 52d have a shape that is different from a triangular shape and appears expedient to a person skilled in the art.

The triangular recesses, in particular two sides of the triangular recesses in each case, are respectively at least partially delimited by two clamping elements 18d of the clamping elements 18d. A part of the cell holder base body 40d arranged on an outer side 54d of the cell holder base body 40d, in particular on a lower side 56d of the cell holder base body 40d, at least partially delimits the triangular recesses, in particular a third side of the triangular recesses. The damping elements 52d are each formed by the respectively two clamping elements 18d, which at least partially delimit the respective triangular recess, in particular in each case two sides of the triangular recess, and the part of the cell holder base body 40d, which is arranged on the outer side 54d of the cell holder base body 40d, in particular on the lower side 56d of the cell holder base body 40d, and at least partially delimits the respective triangular recess, preferably the third side of the triangular recess. The lower side 56d is arranged on a side of the cell holder unit 16d facing the rechargeable battery pack housing bottom 48d. The lower side 56d is arranged on a side of the cell holder unit 16d facing away from the interface 36d. The damping elements 52d are provided to damp, by deformation of the damping elements 52d, an undesired external force application, for example by impacts or the like, to the cell holder unit 16d, in particular the energy cells 22d.

The part of the cell holder base body 40d which is arranged on the outer side 54d of the cell holder base body 40d, in particular on the lower side 56d of the cell holder base body 40d, and at least partially delimits the triangular recesses, preferably the third side of the triangular recesses, is provided to interact with the rechargeable battery pack housing bottom 48d when the rechargeable battery pack housing 38d is being closed in order to transmit the additional clamping force to the energy cells 22d, in particular via the clamping elements 18d. By closing the rechargeable battery pack housing 38d, a deformation of the part of the cell holder base body 40d arranged on the outer side 54d of the cell holder base body 40d, in particular on the lower side 56d of the cell holder base body 40d, can in particular be generated and generates a movement of the clamping elements 18d in the direction of the energy cells 22d in order to additionally clamp the energy cells 22d to the cell holder elements 24d.

The cell holder unit 16d has at least one insertion element 50d in order to support an insertion of an energy cell 22d into the energy cell receiving region 26d during assembly. The at least one insertion element 50d is arranged on at least one cell holder element 24d of the cell holder elements 24d. It is conceivable that an insertion element 50d is arranged on each of the cell holder elements 24d. It is also conceivable that more than one insertion element 50d is arranged on each of the cell holder elements 24d. Furthermore, it is alternatively also conceivable for at least one cell holder element 24d of the cell holder elements 24d to be free from an insertion element 50d. The at least one insertion element 50d is designed as a cut-out in the face of the cell holder element 24d that at least partially delimits the energy cell receiving region 26d. The insertion element 50d is arranged at one end of the cell holder element 24d, at least when viewed along the main extension axis of the energy cell receiving region 26d of the cell holder element 24d. The insertion element 50d designed as a cut-out is U-shaped. Alternatively, it is also conceivable for the insertion element 50d designed as a cut-out to be V-shaped or the like. Furthermore, it is alternatively conceivable that the at least one insertion element 50d is designed as another insertion element that is different from a cut-out and appears expedient to a person skilled in the art.

What is claimed is:

1. An energy cell holding device for an energy storage device, comprising:
at least one cell holder unit configured to receive at least one energy cell, the at least one cell holder unit having at least one cell holder element which at least partially delimits at least one energy cell receiving region for the at least one energy cell; and
at least one clamping unit which comprises at least one clamping element configured to clamp the at least one energy cell when the at least one energy cell is arranged in the at least one energy cell receiving region,
wherein the at least one clamping unit has at least one further clamping element which is configured to additionally clamp the at least one energy cell when the at least one energy cell is arranged in the at least one energy cell receiving region.

2. The energy cell holding device according to claim 1, wherein the at least one further clamping element is configured to be arranged on the at least one cell holder unit in order to additionally clamp the at least one energy cell when the at least one energy cell is arranged in the at least one energy cell receiving region.

3. The energy cell holding device according to claim 1, wherein the at least one clamping unit is designed such that a clamping force on the at least one energy cell is adjustable when the energy cell is arranged in the at least one energy cell receiving region by arranging the at least one further clamping element relative to the at least one energy cell receiving region.

4. The energy cell holding device according to claim 1, wherein the at least one further clamping element is configured to be inserted into the at least one cell holder unit in order to additionally clamp the at least one energy cell when the at least one energy cell is arranged in the at least one energy cell receiving region.

5. The energy cell holding device according to claim 1, wherein the at least one further clamping element is configured to be inserted into the at least one cell holder unit in order to additionally clamp the at least one energy cell when the at least one energy cell is arranged in the at least one energy cell receiving region, such that a clamping force acting on the at least one energy cell is adjustable via an insertion depth of the at least one further clamping element relative to the at least one cell holder unit.

6. The energy cell holding device according to claim 1, wherein:
the at least one further clamping element is configured to be inserted into the at least one cell holder unit in order to additionally clamp the at least one energy cell when the at least one energy cell is arranged in the at least one energy cell receiving region, and
the at least one further clamping element is rotationally symmetrical.

7. The energy cell holding device according to claim 1, wherein:
the at least one further clamping element is configured to be inserted into the at least one cell holder unit in order to additionally clamp the at least one energy cell when the at least one energy cell is arranged in the at least one energy cell receiving region, and
the at least one further clamping element is wedge-like.

8. The energy cell holding device according to claim 1, wherein:
the at least one clamping unit has at least one clamping element receptacle which is different from the at least one energy cell receiving region and is configured to receive the at least further clamping element in order to clamp the at least one energy cell when the at least one energy cell is arranged in the at least one energy cell receiving region, and
the at least one clamping element receptacle is configured to taper.

9. The energy cell holding device according to claim 1, wherein:
the at least one clamping unit has at least one clamping element receptacle which is different from the at least one energy cell receiving region and is configured to receive the at least further clamping element in order to clamp the at least one energy cell when the at least one energy cell is arranged in the at least one energy cell receiving region, and
the at least one clamping element receptacle is arranged at a distance from the at least one energy cell receiving region or directly abutting the energy cell receiving region.

10. The energy cell holding device according to claim 1, further comprising a housing in which at least the cell holder unit is arranged, wherein:
the at least one clamping element is arranged in the at least one energy cell receiving region such that the at least one further clamping element is arranged on a side face of the at least one cell holder unit, and
the at least one further clamping element is configured to clamp the at least one energy cell when the at least one energy cell is arranged in the at least one energy cell receiving region as a result of the housing being closed.

11. The energy cell holding device according to claim 1, wherein the at least one cell holder unit is configured such that the at least one energy cell receiving region is configured to be enlarged by way of applying heat.

12. A rechargeable battery pack comprising:
at least one energy cell; and
a rechargeable battery pack housing having a mechanical and/or electrical interface configured to detachably connect to a consumer unit; and
at least one energy cell holding device according to claim 1.

13. The rechargeable battery pack according to claim 12, wherein:
when viewed in cross section, the at least one energy cell is clamped in the at least one energy cell receiving region by way of three clamping points, and
at least one clamping point of the three clamping points is different from the at least one clamping element.

14. The rechargeable battery pack according to claim 12, wherein the at least one further clamping element is formed by the rechargeable battery pack housing.

15. A system, comprising:
a rechargeable battery pack having an energy cell holding device according to claim 1; and
a further rechargeable battery pack having an energy cell holding device also according to claim 1,
wherein the cell holder unit of the energy cell holding device of the rechargeable battery pack and the energy cell holder unit of the energy cell holding device of the further rechargeable battery pack as well as the clamping element of the clamping unit of the rechargeable battery pack and the clamping element of the clamping unit of the further rechargeable battery pack are designed to be at least substantially identical.

16. The energy cell holding device according to claim 1, wherein the energy cell holding device is a rechargeable battery pack.

17. The energy cell holding device according to claim 1, wherein the at least one energy cell receiving region is a single energy cell receptacle.

18. The rechargeable battery pack according to claim 12, wherein the at least one further clamping element is formed by an external housing part of the rechargeable battery pack housing.

19. The rechargeable battery pack according to claim 12, wherein the at least one further clamping element is formed by a rechargeable battery pack housing bottom of the rechargeable battery pack housing.
